(19) United States
(12) Patent Application Publication
(10) Pub. No.: US 2008/0309045 A1
(43) Pub. Date: Dec. 18, 2008

(54) Energy recovery system

(76) Inventors: Anderson Forbes Johnson, JR., Hardyville, VA (US); Michael Lee Johnson, Hardyville, VA (US); William Eric Johnson, Bavon, VA (US)

Correspondence Address: Anderson F. Johnson, Jr., 415 Mallard Drive, Hardyville, VA, 23070, US

(21) Appl. No.: 12/214,062

(22) Filed: Jun. 17, 2008

Related U.S. Application Data
(60) Provisional application No. 60/934,994, filed on Jun. 18, 2007.

(51) Int. Cl. B60G 17/00

(52) U.S. Cl. 280/124.161

(57) ABSTRACT

A significant advantage of this system is that it captures and utilizes a distinctive amount of energy that normally is lost. Also, it is a system that the vehicle manufacturers can easily build into their ‘ready for market’ models or it may be offered to vehicle owners as a DIY attachment to their vehicles. While it should be apparent to those knowledgeable in the art of hydraulics, this system may be adaptable to other applications, hydraulic or not, where energy is being lost or wasted to conserve that energy. Most of the vehicle references in this specification have been made to automobiles, but it should be pointed out that the applicability of the proposed system to trucks is very sound and worthwhile. With worldwide emphasis now on energy conservation, this system provides a realistic cost-saving means.

This invention is a continuation of the developmental efforts of provisional patent application No. 60/934,994 filed Jun. 18, 2007.

### FIELD OF THE INVENTION

The invention is related to the field of automotive vehicles and any vehicle supported by wheels, springs and shock absorbers mounted within a carriage.

### BACKGROUND OF THE INVENTION

Anyone who has traveled today's highways must have observed the bodies of vehicles moving up and down on their chassis in response to the unevenness of the highway surface. Means are provided in most vehicles to dampen or absorb these vertical undulations for greater rider comfort and to aid in better steerage of the vehicle.

In the front of today's automobiles, there usually are two coil springs and two shock absorbers, one on each side. A shock absorber usually contains a coil spring and a piston and cylinder, the latter combination being tunable through selection of its components to fully or partially compress the air in its cylinder before the air is released to the outside.

The rear of today's automobiles usually incorporates coil springs, leaf springs and shock absorbers depending on the comfort desired. Certain vehicles actually employ air cylinders to suppress the vertical undulations. The heat contained in the absorbed energy usually is dissipated into the air currents surrounding the absorbers.

### SUMMARY OF THE INVENTION

Assuming that the average weight of an automobile is 4,000 pounds and that the weight is equally divided between the front and rear, a great deal of energy is required to push that weight upwards even an inch. Also, at a typical speed on today's highways of 60 MPH, these vertical undulations may occur thousands of times per mile at a huge waste of energy.

Anyone conversant in the hydraulic field will realize the applicability to this system of other sandwich and control valves such as flow, shuttle, fixed orifice, electro-proportional, reducing/relieving, pressure adjustable, poppet, spool, diverter, 2-way, 3-way and accumulator sense.

### DESCRIPTION OF THE INVENTION

It is the purpose of this invention to provide a means of recovering that wasted energy and utilizing it for the greater efficiency of the vehicle. Pursuant to that goal, a closed system of hydraulic cylinders (single or double acting), check valves, hydraulic motors, accumulators, hydraulic hoses and hydraulic fluid is proposed to capture the energy generated by the combined chassis and body movements described above. The hydraulic motors may be used to help power on-board equipment such as alternators, battery chargers, air conditioners or to assist the main motive-force of the vehicle.

Very likely, owners will want a power meter mounted on the dash of their vehicles to indicate the amount of power recovered. Quite possibly a second meter may be desired to show the total improvement in mileage. Then, on multi-lane highways, the drivers could determine which lanes provide the best mileage.

### BRIEF DESCRIPTION OF THE DRAWING

FIG. 1 is a schematic drawing that allows one to understand how the system would function. When the piston A and piston rod B of the double acting cylinder E move downward, fluid is forced through check valve C to drive hydraulic motor D while fluid is sucked from the accumulator G through the check valves F and H into the upper chamber of cylinder E. Afterwards, the upward travel of pistons A and piston rod B will pull fluid from the accumulator G through check valves H and J and push the captive fluid in the upper portion of cylinder E through check valve K to drive motor D. The spent fluid leaving motor D will then pass though check valve L to the accumulator G, thus completing a cycle. It is important to note that it is unnecessary for the piston A and piston rod B to make a complete travel in any direction, up or down, since partial strokes will achieve the desired effort of capturing the energy submitted to the system.

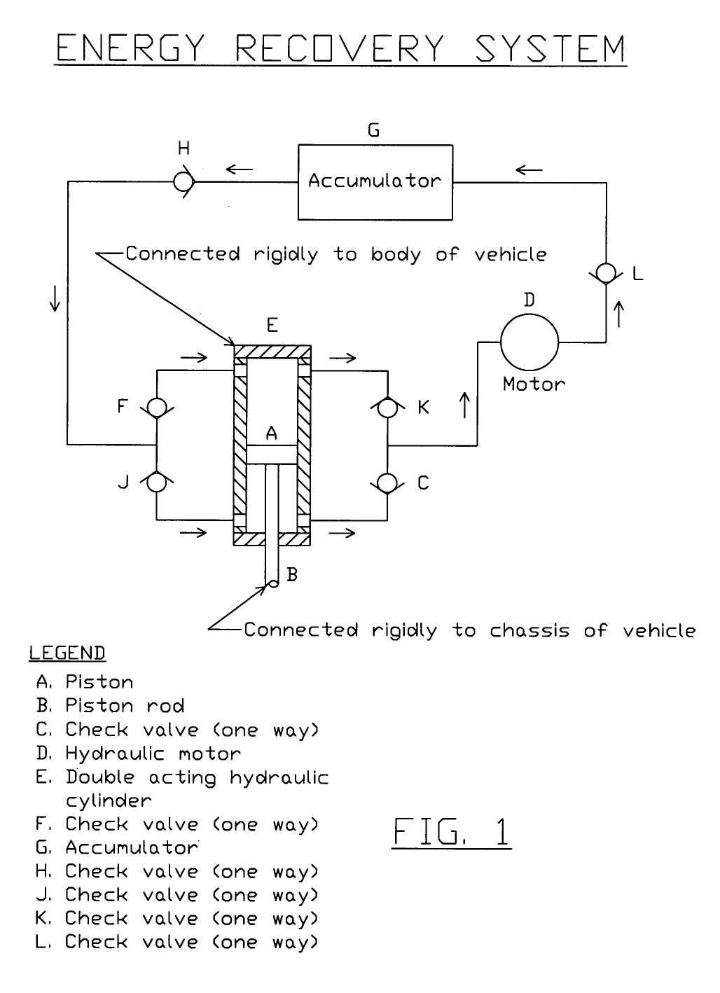

1. What we claim by this invention is a system comprised of at least one or more accumulators, hydraulic cylinders, hydraulic motors with check valves so deployed along with other hydraulic devices as required to achieve the functional equivalent of the hydraulic circuitry shown in FIG. 1 so that when interposed between the chassis and body of a vehicle, the energy generated between the chassis and body of a moving vehicle may be captured and utilized.

2. In other systems, vehicular or other, we claim the ability when devices equivalent to the above are deployed to capture and reuse the energy often contained in systems such as liquid, steam or gas.
